(19) United States
(12) Patent Application Publication
(10) Pub. No.: US 2005/0288969 A1
(43) Pub. Date: Dec. 29, 2005

(54) Warranty for a security

(76) Inventors: Steven S. Schuver, St. Louis, MO (US); David D. Schuver, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/111,200

(22) Filed: Apr. 21, 2005

Related U.S. Application Data
(63) Continuation-in-part of application No. 10/875,704, filed on Jun. 24, 2004.

(51) Int. Cl. G06F 17/60

(52) U.S. Cl. 705/4

(57) ABSTRACT

A method for warranting a security comprises the steps of obtaining a security and purchasing a warranty policy for warranting against a change in the value of the security. A system for warranting a security is also disclosed.

### CROSS REFERENCE TO RELATED APPLICATIONS

This application is a continuation-in-part of U.S. patent application Ser. No. 10/875,704 filed on Jun. 24, 2004.

### BACKGROUND OF THE INVENTION

This invention relates to protecting a security, securities, a portfolio of securities, or a portion of a portfolio of securities and more particularly to a system and method for warranting the value of a security or any change in the value of a security.

Investors may invest in numerous types of securities in an attempt to achieve short-term or long-term appreciation in the price or value of the security. In particular, an investor among other things may invest in or obtain an interest in stocks, mutual funds, options, commodities, futures, derivatives, stock index futures, certificates of deposit, exchange traded funds, or bonds by purchasing such securities. Initially, such securities or assets have a purchase price or basis. The investor attempts to maximize the return on investment by selecting assets or securities that either increase in value or do not allow their principal to erode or decline in value. Due to the unpredictable and volatile nature of securities, investors may find it advantageous to protect the principal by preventing any loss that may occur in the purchase price or basis of the security. One way to try to protect against such an occurrence is to purchase an option contract. For example, an option contract gives an investor the right, but not the obligation, to purchase or sell a certain number of shares of stocks or other types of securities at a specific price at a specific future time. An investor pays a price for the right to purchase or sell the certain number of shares at the specific price at a future date. If the investor does not purchase or sell the stock, the investor is out the money paid to purchase the option contract. However, such option contracts are complex, difficult to understand, date limited, risky, and expensive. Further, such option contracts are only available for a limited number of stocks and cannot be purchased for other securities such as mutual finds. Accordingly and unfortunately, options contracts do not offer the protection sought or needed.

Some investors have bought government bonds or debt obligations that are backed or guaranteed by a government in an attempt to protect against a decrease in value in a security. However, such bonds pay an interest rate that is below the market interest rate making it a less attractive security. Additionally, some government-backed bonds require a large amount of money to purchase these bonds. Thus, the purchases of such bonds are only practical for large institutions, banks, or companies. Again, such bonds do not allow an individual investor the opportunity to hedge their risks.

Therefore, it would be desirable to protect an asset or a security from declining in value. It is also desirable to protect an individual's portfolio or a portion of the portfolio that may be comprised of combinations of various securities. It would also be advantageous to offer a product, such as a warranty, for protecting against a change in the value of a security.

The present invention is designed to obviate and overcome many of the disadvantages and shortcomings associated with attempting to protect a security. In particular, the present invention is a system and method that warrants or guarantees a security. The present invention provides a warranty, warranty policy, or contract that is used to guarantee or warrant against a change in value of a security, a portfolio of securities, or a portion of a portfolio of securities. Moreover, the system and method of the present invention can be employed to warrant against a decrease or an increase in the price of a security.

### SUMMARY OF THE INVENTION

In one form of the present invention, a method for warranting a security comprises the steps of obtaining a security and purchasing a warranty policy for warranting against a change in the value of the security.

In another form of the present invention, a system for warranting a security comprises a computer system for entering information related to warranting a security and a server system for receiving the entered information and for calculating a premium for a warranty policy for warranting a security and the server system for transmitting the premium to the computer system.

In still another form of the present invention, a method for warranting a security comprises obtaining an interest in a security and purchasing a warranty policy for warranting against a change in the value of the security.

Another form of the present invention is a method for warranting a portfolio of securities that comprises the steps of obtaining a portfolio of securities and purchasing a warranty for warranting against a change in the value of the portfolio.

In yet another form of the present invention, a method of warranting a portion of a portfolio of securities comprises the steps of obtaining a portfolio of securities and purchasing a warranty for warranting against a change in the value of a portion of the portfolio.

In another form of the present invention, a system for warranting a portfolio of securities comprises a computer system for entering information related to warranting a portfolio of securities and a server system for receiving the entered information and for calculating a premium for a warranty for warranting a portfolio of securities and the server system for transmitting the premium to the computer system.

Another form of the present invention is a method for warranting a portfolio of securities that comprises the steps of obtaining an interest in a portfolio of securities and purchasing a warranty for warranting against a change in the value of the portfolio of securities.

In still another form of the present invention, a system for warranting a portion of a portfolio of securities comprises a computer system for entering information related to warranting a portion of a portfolio of securities and a server system for receiving the entered information and for calculating a premium for a warranty for warranting a portion of a portfolio of securities and the server system for transmitting the premium to the computer system.

In yet another form of the present invention, a method for purchasing a warranty for a security over a computer network comprises the steps of accessing a web site for purchasing a warranty for a security, entering information relating to a security to be warranted, reviewing information relating to a premium to be paid for the warranty for a security, and paying for the premium.

In one form of the present invention, a system for purchasing a warranty for a security comprises a computer system capable of being assessed over an Internet, the computer system capable of providing various screens and for receiving entered information relating to a security to be warranted, determining a premium to be paid for the warranty for a security, and for receiving entered information relating to payment for the premium.

In still another form of the present invention is a method for purchasing a warranty for a portfolio of securities over a computer network that comprises the steps of accessing a web site for purchasing a warranty for a portfolio of securities, entering information relating to portfolio of securities to be warranted, reviewing information relating to a premium to be paid for the warranty for the portfolio, and paying for the premium.

In yet another form of the present invention, a method for providing a warranty for a security over a computer network comprises the steps of providing a web site for purchasing a warranty for a security, receiving information relating to a security to be warranted, determining a premium to be paid for the warranty for a security, and receiving payment for the premium.

In another form of the present invention, a method for providing a warranty for a portfolio of securities over a computer network comprises the steps of providing a web site for purchasing a warranty for a portfolio of securities, receiving information relating to a portfolio of securities to be warranted, determining a premium to be paid for the warranty for a portfolio of securities to be warranted, and receiving payment for the premium.

In still another form of the present invention, a method for purchasing a warranty for a portion of a portfolio of securities over a computer network comprises the steps of accessing a web site for purchasing a warranty for a portion of a portfolio of securities, entering information relating to the portfolio of securities to be warranted, reviewing information relating to a premium to be paid for the warranty for the portion of the portfolio of securities, and paying for the premium.

In yet another form of the present invention, a system for purchasing a warranty for a portfolio of securities is disclosed that comprises a computer system capable of being assessed over an Internet, the computer system capable of providing various screens and for receiving entered information relating to a portfolio of securities to be warranted, determining a premium to be paid for the warranty for the portfolio, and for receiving entered information relating to payment for the premium.

In another form of the present invention, system for purchasing a warranty for a portion of a portfolio of securities comprises a computer system capable of being assessed over an Internet, the computer system capable of providing various screens and for receiving entered information relating to a portion of a portfolio of securities to be warranted, determining a premium to be paid for the warranty for a portion of a portfolio of securities, and for receiving entered information relating to payment for the premium.

In light of the foregoing comments, it will be recognized that a principal object of the present invention is to provide a system and/or a method for warranting against a loss or decline in the purchase price or the value of a security as well as a profit or increase in the value of a security as in the case of a short sale.

A further object of the present invention is to provide a system and method for providing a warranty for an asset or a security.

Another object of the present invention is to provide a system and method for warranting against an increase in a price of a security.

A still further object of the present invention is to provide a system and method for warranting a security that is easy to use and understand.

Another object of the present invention is to provide a system and method for warranting a portfolio of securities or a portion of a portfolio of securities.

A further object of the present invention is to provide a system and method for warranting a security that provides for the selection of various parameters of a warranty policy.

These and other objects and advantages of the present invention will become apparent after considering the following detailed specification in conjunction with the accompanying drawings, wherein:

### BRIEF DESCRIPTION OF THE DRAWINGS

FIG. 1 is a flow chart diagram illustrating a preferred operation of the method for warranting a security according to the present invention;

FIG. 2 is a flow chart diagram illustrating a method for selecting warranty policy requirements;

FIG. 3 is a flow chart diagram illustrating a method for calculating a premium amount;

FIG. 4 is a flow chart diagram illustrating a method for preparation of a warranty policy;

FIG. 5 is a flow chart diagram illustrating a method for determining whether a claim may be made against a warranty policy for warranting a security;

FIG. 6 is a flow chart diagram illustrating a method for renewing a warranty policy;

FIG. 7 is a block diagram of a system for warranting a security constructed according to the present invention;

FIG. 8 is an illustration of a screen that may be presented during use of the system for warranting a security to enter warranty parameters;

FIG. 9 is an illustration of a screen that may be presented during use of the system for warranting a security to accept a premium; and

FIG. 10 is an illustration of a screen that may be presented during use of the system for warranting a security to enter warranty parameters for a portfolio of securities.

### DETAILED DESCRIPTION OF THE PREFERRED EMBODIMENTS

Referring now to the drawings, wherein like numbers refer to like items, number 10 identifies a preferred method for warranting a security according to the present invention. With reference now to FIG. 1, the method 10 is shown to comprise a first step 12 in which a user obtains, acquires, or purchases a security. Examples of securities that may be obtained, acquired, or purchased are stocks, bonds, mutual funds, options, commodities, futures, derivatives, stock index futures, certificates of deposit, and exchange traded funds. A second step 14 of the method 10 comprises a user purchasing a warranty policy to protect against a change in the value of the security obtained in the step 12. Proof of ownership or interest in the security may be required in order to purchase or issue the warranty policy. In this manner, if the value or the price of the security decreases over time, the user will have a warranty against any decrease in the value or price of the security. In particular, if at the end of the warranty policy term the price of the security is below the value or warranty price, the warranty policy will pay the difference between the warranty price of the security and the value or the price of the security on the day that the warranty policy terminates. It is contemplated that a claim may be made against the policy within a term of days as defined by the warranty policy. Further, it is possible and contemplated that a user may purchase the warranty policy at any time the user owns or has an interest in the security. In other words, it is not necessary that the user purchase the warranty policy when a security is initially purchased or obtained. For example, if the user purchases a share of stock on January 1 for $10 and the price of the stock increases to $15 by July 1 then the user may purchase a warranty policy on July 1 to protect against a decrease in the price of the stock as of July 1. In essence, the user may lock in the price paid for obtaining the security plus the gain in the price of the stock. It is also possible that the user may purchase the warranty policy when the security is initially purchased or obtained and later on purchase another warranty policy if the security increases in price or value. Further, it is possible that the warranty policy may protect against a gain in the price or value of a security in the case of a short sale. A security may be obtained in several ways as by gift, inheritance, purchase, settlement, wager, theft, discovery or treasure, contract, or by agreement.

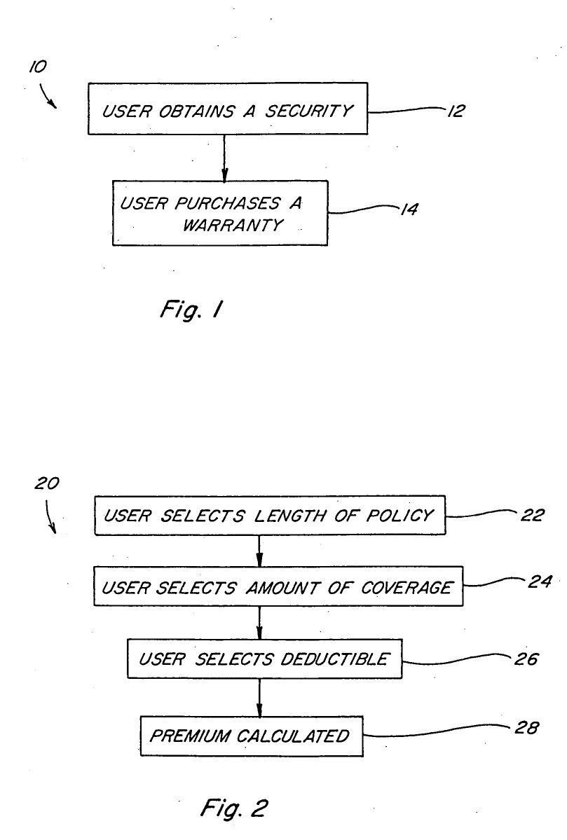

FIG. 2 shows a process for the user to use in selecting policy requirements for purchasing the warranty policy. The policy requirements include various parameters that may be selected prior to purchasing a warranty policy. In a first step 22, a user selects the length or term of the warranty policy. For example, the user may want to warrant against a loss in the purchase price or the value of a security for a term of one year. Further, any decrease occurring after the end of the term selected is not covered by the warranty policy. As another example, the user may want to warrant against an increase in the value or price of a security. Once the length is selected, the user selects the amount of coverage as shown in a second step 24. The user may decide that only warranting a portion of the value or the price of the security is required or desired. For example, if a security having a value of $100 is purchased, the user may decide that only half of this amount or $50 needs to be warranted. After selecting the amount of coverage, the user needs to decide if the user is willing to pay a deductible. In this a next step, step 26, the user is required to determine whether the user will pay a deductible prior to the warranty policy paying out some amount of coverage. In a next step, step 28, a premium amount is calculated based upon the parameters of policy length, policy amount, and policy deductible.

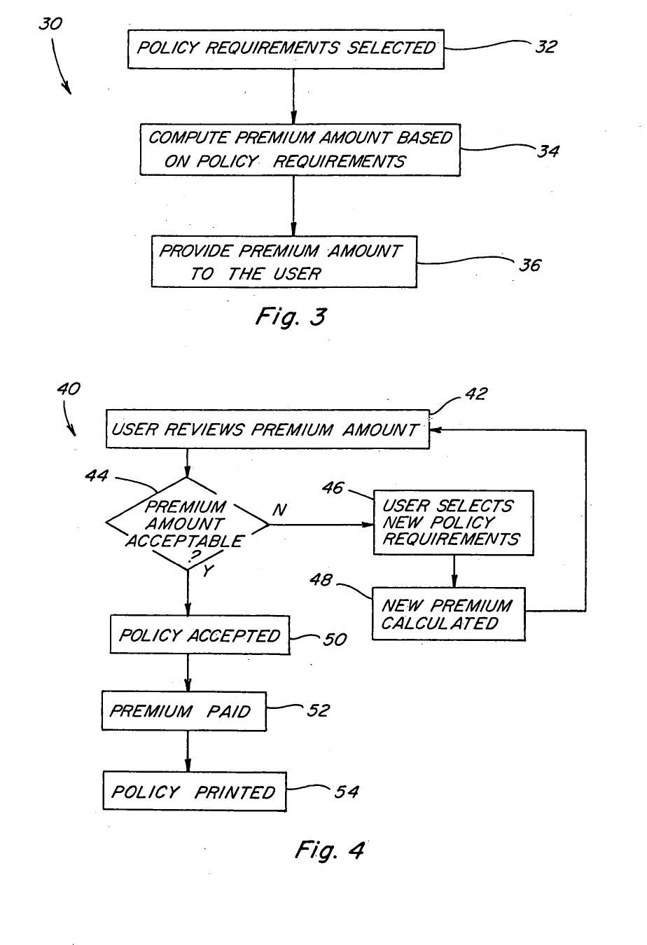

With reference now to FIG. 3, a flowchart illustrates a process 30 for calculating a premium amount. First, in a step 32, the user selects policy requirements that may include identification of the security, policy term, policy amount, and policy deductible. Once the policy requirements are selected a premium amount is calculated based on the policy requirements. This is accomplished in a step 34. Some parameters used to calculate or compute the premium amount may include whether the security is volatile. If the security is volatile then this may require a higher premium. Also, a coverage period of a long term may impact the price of the premium. The amount of coverage, the term, and the deductible amount, if any, may impact the calculated premium amount. Once calculated, the premium amount is provided to the user in a step 36.

FIG. 4 is a flowchart that illustrates a process 40 for creating a warranty policy for a security. The user reviews or evaluates the premium amount that has been calculated based on various policy requirements in a step 42. Once the evaluation is completed, the user determines, in a step 44, whether the premium amount is acceptable. If the premium is not acceptable then the user enters new policy requirements in a step 46. As discussed previously, new policy requirements may include policy term, policy amount, or policy deductible. In a next step 48, a new premium amount is calculated based upon the new policy requirements entered in the step 46. The new premium amount is provided to the user in the step 42 where the user again reviews the premium amount.

If in the step 44 the user determines that the premium amount is acceptable, a next step 50 is encountered where the warranty policy is accepted. Next, in a step 52, the premium amount is paid by the user. Finally, in a step 54, the warranty policy is written or printed and provided to the user. It is also possible that steps 52 and 54 may be reversed. In particular, the warranty policy may be printed and provided to the user with a bill or invoice to pay the premium amount.

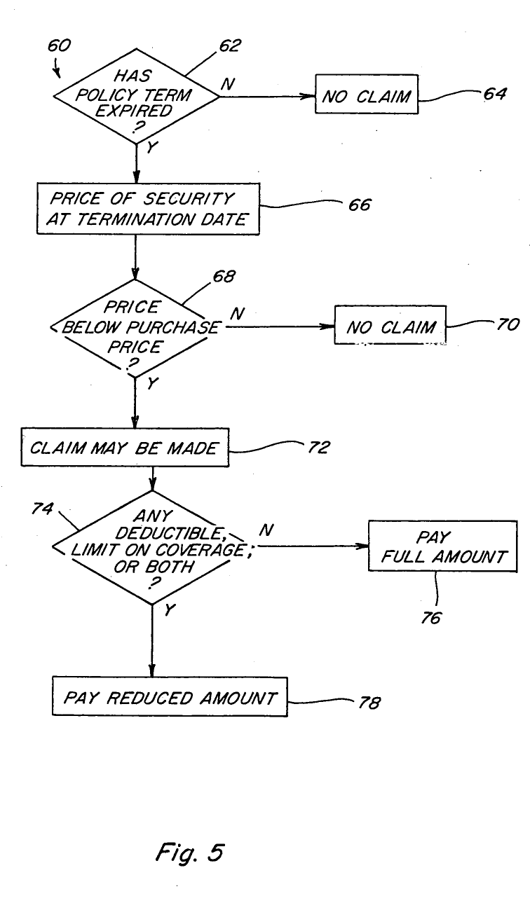

Referring now to FIG. 5, a flow chart illustrates a method 60 for determining whether a claim may be made against a warranty policy for warranting a security. The method 60 commences with a first step 62 in which it is determined whether the term of the warranty policy has expired. If it is determined that the term of the policy has not expired then no claim may be made as is shown in a step 64. If on the other hand it is determined that the term of the policy has expired then the price of the security on the last day of the term is reviewed in a step 66. In a next step 68, it is determined whether the price of the security on the last day of the term of the policy is below the warranted price. If it is not then no claim may be made against the policy, as is shown in a step 70. In this particular situation the user would be out the amount of the premium paid for the warranty policy. However, as depicted in a step 72, if the price is below the warranted price then a claim may be made within the terms of the warranty policy. Although it has been described that a claim may be made if the price of the security is below the warranted price on the last day of the term of the policy, it is possible that the terms of the warranty policy will allow for a claim to be made during a window period. An example of a window period may be seven days prior to the last day of the term of the policy. Prior to a payment being made under the warranty policy, it may be required to review the warranty policy, as illustrated in a step 74, to determine if there was a deductible amount, a limit on coverage, or both. If it is determined that the policy does not contain a deductible amount, a limit on coverage, or both, then the full policy amount is paid to the user. This is depicted in a step 76. In particular by way of example only, if the security to be warranted was one share of stock that had a purchase price of $100 and at the expiration of the term of the warranty policy the price of the stock was $90 then the policy would pay $10 to the user. If in the step 74 it is determined that there were limitations in the policy then a reduced amount is paid to the user as is shown in a step 78. For example, using the same numerical amounts as above, and assuming a $5 deductible, then the policy would pay to the user $5. If the policy had a limit that it would pay for 95% coverage then the warranty policy would pay $5 to the user. In case of a short sale, if there is an increase in the value or price of the share or shares shorted then the policy would make a payout to the user.

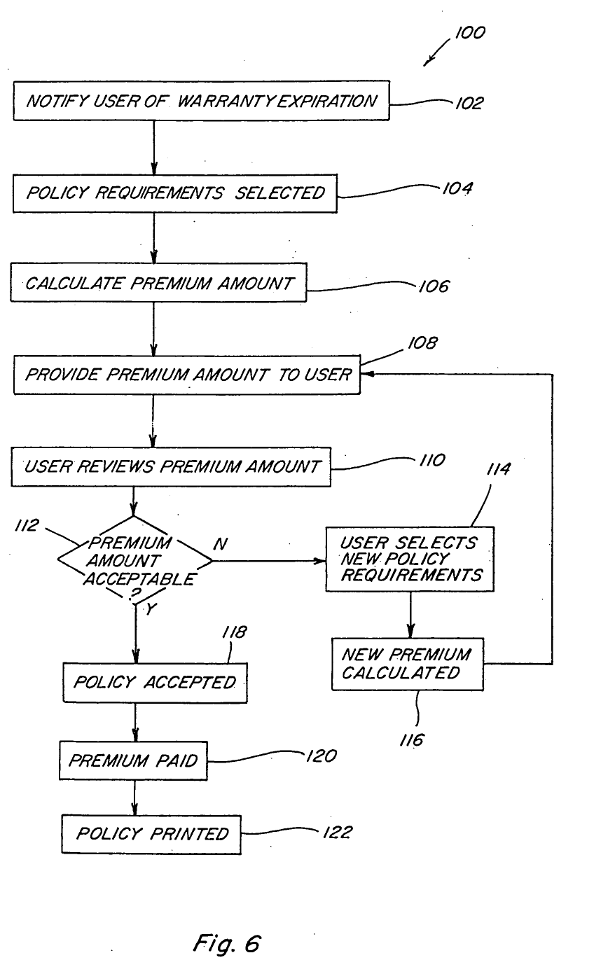

FIG. 6 shows a flow chart of a process 100 for renewing a warranty policy for warranting a security. In a first step 102 the user is notified of the expiration of the warranty policy. In a next step 104 the user is able to select new policy requirements for a renewed warranty policy for warranting a security. In the step 104 the user may select such parameters as a new policy term, a new amount of coverage, a new deductible amount, and a new price for the security or the parameters may remain the same as in the original policy. After the user selects the policy requirements a premium amount is calculated in a step 106. Once the premium has been calculated the premium amount is submitted to the user in a step 108. The user reviews the premium amount in a step 110. A determination is made in a step 112 as to whether the premium amount is acceptable. If the amount is not acceptable then the user may select new policy requirements in an attempt to lower the premium amount. This is indicated in a step 114. Upon selection of new policy requirements another premium is calculated in a step 116. Once the new premium is calculated the new premium is submitted to the user in the step 108. If in the step 112 it is decided by the user to accept the premium amount the policy is accepted by the user in a step 118. Further, the user in a step 120 pays the premium and the policy is printed or written in a step 122. As previously indicated, the performance of steps 120 and 122 may be reversed. For example, it is possible that the policy is printed and a bill is then submitted for payment of the premium.

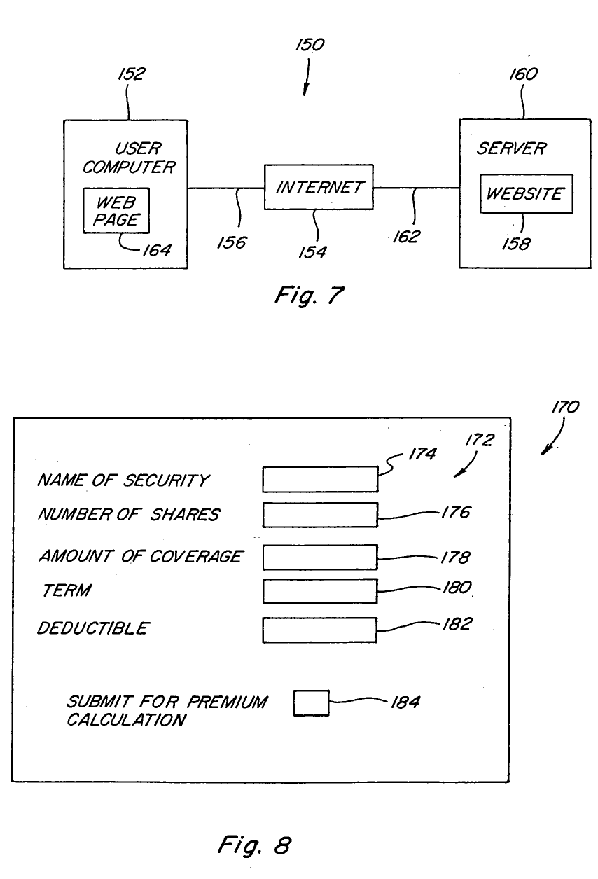

A system for warranting a security 150 is illustrated in FIG. 7. The system 150 is shown comprising a user computer system 152 that is capable of being connected to the Internet 154 by a communications connection 156 such as a telephone line, cable, ISDN lines, fiber optic lines, wireless connections, satellites, or other suitable means of connection. Through use of the connection 156 to the Internet 154, the computer 152 is capable of accessing a website 158 on a computer system or a server 160 over a connection 162. The website 158 may be a website of a brokerage, a bank, a warranty company, an insurance company, or any other entity that a user may purchase a security. As described for the connection 156, the connection 162 may include a telephone line, cable, ISDN lines, fiber optic lines, wireless connections, satellites, or other means of connection. The server 160 is capable of transmitting to the user computer 152 one or more web pages 164 for viewing by a user of the user computer 152.

The user computer 152 is allowed access to the server 160 through use of a commonly available web browser or similar software package or application. The server 160 is capable of hosting the website 158 which presents various screens or web pages 164 to the user computer 152. A user operating the user computer 152 is able to interact with the website 158 being hosted by the server 160. In particular, a user may be presented with various screens or web pages 164 with such web pages 164 presenting information concerning the purchasing of a security and the purchasing of warranty for a security. Further, the web pages 164 may have other information such as selecting a length of a policy term, an amount of coverage, a deductible amount, and entering of information concerning a security already owned.

The user may be presented with a web page or screen 170 as illustrated in FIG. 8. As shown, underwriting information or warranty parameters 172 are presented for selection or entry by the user. The user is requested to enter information concerning the name or symbol of the security to be warranted in a box 174 and the number of shares to be warranted in a box 176. The amount of coverage desired is entered in a box 178. For example, the user may determine that only half of the value of the security to be warranted needs to be covered and this amount is placed in the box 178. The term of the policy is selected and entered in a box 180. The user can determine the length of the term of the policy. Also, if a deductible amount is to be factored into the calculation of the premium, the user may enter a deductible amount in a box 182. Once the user has entered the warranty parameters 172, a button 184 may be selected to transmit the warranty parameters 172 to the server 160 in order to determine or calculate a premium for warranting the security presented in the box 174.

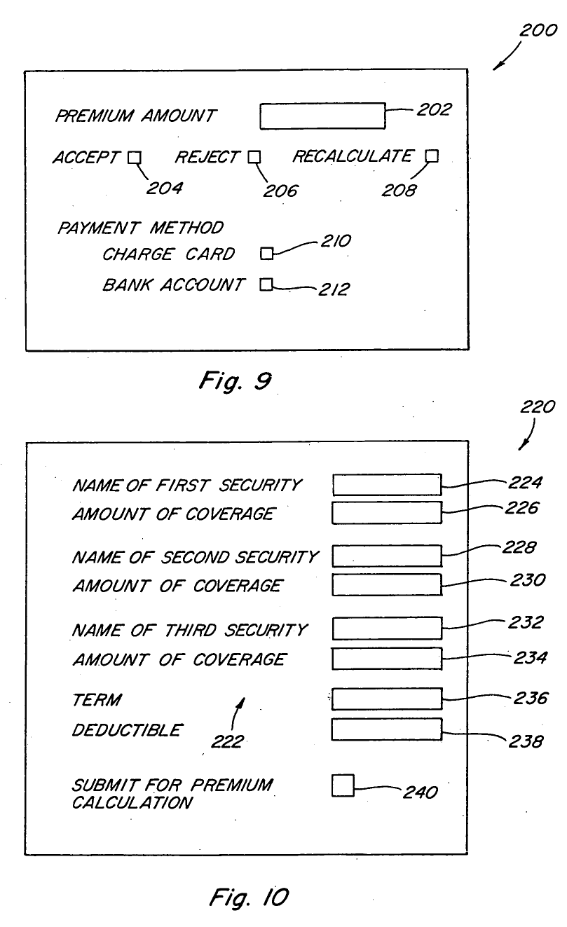

Once the server 160 receives the warranty parameters 172, a premium is calculated. The premium amount is then sent to the user computer 152 to be displayed as a screen or a web page 164. FIG. 9 depicts a web page 200 that may be presented on a display associated with the user computer 152. The web page 200 has a box 202 in which the premium amount is displayed for review by the user. The user may accept the premium amount by selecting a button 204, reject the premium amount by selecting a button 206, or recalculate a premium amount by selecting a button 208. If the button 204 is selected, the user may be requested to indicate a payment method for the premium amount. If the premium is to be paid by a credit card then a box 210 is selected and the user is taken to a new web page to enter further information concerning the credit card. If the premium is to be paid by a bank account then a box 212 is selected and a new web page is presented for entry of bank account information. Other methods of payment, such as cash, check, invoice, or being billed are contemplated and possible and such methods may be incorporated into the web page 200. If the user decides that the premium amount is too high and warranting the security is to be foregone then the box 206 is selected and the user may be taken to a home page of the server 160. On the other hand, if the user selects the box 208, the user will be presented the web page 170 again to enter warranty parameters 172 in an attempt to recalculate the premium amount. For example, the premium amount presented in the box 202 may be more than the user wants to pay. In order to reduce the premium amount the user selects the box 208 and the web page 170 is presented for entry of other amounts. The user, in an attempt to lower the premium, may enter into the box 182 a higher deductible amount. In this manner, the premium amount is recalculated and the recalculated amount for the premium may be low enough that the user selects the accept box 204. As can be appreciated, several other web pages may be presented to the user. By way of example, web pages may be presented that include the conditions and terms of the warranty policy and payment confirmation.

Although not shown, the computer system 152 may include peripheral devices such as a keyboard, a speaker, a display, a printer, a modem, a network card, and any other suitable device. The computer system 152 may be a personal computer having a microprocessor, memory, a hard drive having stored thereon an operating system and other software, and input devices such as a mouse, a keyboard, a CD-ROM drive, or a floppy disk drive. The computer system 152 may also be a PDA type device, a cell phone, or other hand held type computer device that allows for receiving and transmitting information or data. Further, the server 160 may take on various known forms for a server including a personal computer, a computer system, or a network. Also, although the Internet 154 is disclosed, it is also possible that the system 150 be located on a LAN or other closed network system.

It is also possible to insure a number of securities or a portfolio through use of the present invention. With reference now to FIG. 10, a web page 220 is illustrated that provides for entry of more than one security for calculating one premium to warrant the securities or the portfolio. The web page 220 requests the user to enter various warranty parameters 220. In a box 224, the name of the first security is entered. Below the box 224 is a box 226 in which the amount of coverage for the first security is entered. Once the information for the first security has been entered, information relating to a second security and a third security may be entered in boxes 228, 230, 232, and 234. After the security information has been entered the term for the warranty policy is entered into in a box 236. A deductible amount, if any, is entered in a box 238. After all of the warranty parameters 222 have been entered then a button 240 may be selected to calculate a premium amount. The information relating to the warranty parameters 222 are transmitted to the server 160 in order to determine or calculate a premium for warranting the securities presented in the boxes 224, 228, and 232. It is also possible that there are more boxes for entering other securities or other web pages similar to the web page 220. It is also contemplated that the term and the deductible amount may be individually selected for each security. In this manner, a portion of the portfolio of securities may be warranted. For example, the first security entered may be covered for 100% value and have no deductible, the second security entered may be covered for 50% value and have a deductible amount selected, and the third security entered may not be covered at all. Further, a listing of individual premiums per security may be provided in which a user may select which security will be warranted. It may be that the premium for one of the securities to be warranted is determined to be too high and the user may select not to warrant this particular security.

Although the present system and method have been described by use of electronic means, it is also possible that an agent, a broker, or other salesperson may provide the policy to a user. For example, an agent may discuss in person or over the telephone the various securities to be warranted and provide a quote for coverage to a user. The user may review the quote and then determine whether to warrant the security or securities. In this manner, the user does not directly interact with the system and relies on the agent for information and the premium quote. Also, the agent or the system may already have predetermined premiums or policies for any type security, for any amount of coverage, for any length or term, and for any deductible amount. The user may select the warranty policy and premium from a listing of the predetermined premiums or polices.

From all that has been said, it will be clear that there has thus been shown and described herein a system and method for warranting a security which fulfills the various objects and advantages sought therefore. It will become apparent to those skilled in the art, however, that many changes, modifications, variations, and other uses and applications of the subject system and method for warranting a security are possible and contemplated. All changes, modifications, variations, and other uses and applications which do not depart from the spirit and scope of the invention are deemed to be covered by the invention, which is limited only by the claims which follow.

1. A method for warranting a security comprising the steps of:
obtaining a security; and
purchasing a warranty policy for warranting against a change in the value of the security.

2. The method of claim 1 wherein the step of purchasing a warranty policy comprises the step of determining a premium to be paid for purchasing the warranty policy.

3. The method of claim 1 wherein the step of purchasing a warranty policy comprises the step of determining the length of the warranty policy.

4. The method of claim 1 wherein the step of purchasing a warranty policy comprises the step of determining an amount of coverage.

5. The method of claim 4 wherein the amount of coverage is equal to the value of the security.

6. The method of claim 4 wherein the amount of coverage is less than the value of the security.

7. The method of claim 1 wherein the step of purchasing a warranty policy comprises the step of determining a deductible.

8. The method of claim 1 further comprises the steps of obtaining a second security and warranting against a change in the value of the second security.

9. The method of claim 8 wherein the warranting step comprises determining a second premium to be paid for warranting against a change in the value of the second security.

10. A system for warranting a security comprising:
a computer system for entering information related to warranting a security; and
a server system for receiving the entered information and for calculating a premium for a warranty policy for warranting a security and the server system for transmitting the premium to the computer system.

11. The system of claim 10 wherein the computer system is capable of having entered therein information related to a length for a warranty policy.

12. The system of claim 10 wherein the computer system is capable of having entered therein information related to a deductible amount for a warranty policy.

13. The system of claim 10 wherein the computer system is capable of having entered therein information related to an amount of coverage for a warranty policy.

14. The system of claim 10 wherein the computer system is capable of having entered therein information related to warranting a second security.

15. The system of claim 10 wherein the server system is capable of recalculating a premium amount based upon revised information entered in the computer system.

16. A method for warranting a security comprising the steps of:
obtaining an interest in a security; and
purchasing a warranty policy for warranting against a change in the value of the security.

17. The method of claim 16 wherein the step of purchasing a warranty policy comprises the step of determining a premium to be paid for purchasing the warranty policy.

18. The method of claim 16 wherein the step of purchasing a warranty policy comprises the step of determining the length of the warranty policy.

19. The method of claim 16 wherein the step of purchasing a warranty policy comprises the step of determining an amount of coverage.

20. The method of claim 16 wherein the step of purchasing a warranty policy comprises the step of determining a deductible.

21. A method for warranting a portfolio of securities comprising the steps of:
obtaining a portfolio of securities; and
purchasing a warranty for warranting against a change in the value of the portfolio.

22. The method of claim 21 wherein the step of purchasing a warranty comprises the step of determining a premium to be paid for purchasing the warranty.

23. The method of claim 21 wherein the step of purchasing a warranty comprises the step of determining the length of the warranty.

24. The method of claim 21 wherein the step of purchasing a warranty comprises the step of determining an amount of coverage.

25. The method of claim 24 wherein the amount of coverage is equal to the value of the portfolio.

26. The method of claim 24 wherein the amount of coverage is less than the value of the portfolio.

27. The method of claim 21 wherein the step of purchasing a warranty comprises the step of determining a deductible.

28. The method of claim 21 wherein the step of purchasing a warranty comprises the step of determining a premium to be paid for purchasing the warranty for warranting against a change in the value of a portion of securities in a portfolio.

29. A method of warranting a portion of a portfolio of securities comprising the steps of:
obtaining a portfolio of securities; and
purchasing a warranty for warranting against a change in the value of a portion of the portfolio.

30. The method of claim 29 wherein the step of purchasing a warranty comprises the step of determining a premium to be paid for purchasing the warranty.

31. The method of claim 29 wherein the step of purchasing warranty comprises the step of determining the length of the warranty.

32. The method of claim 29 wherein the step of purchasing a warranty comprises the step of determining an amount of coverage.

33. The method of claim 29 wherein the step of purchasing a warranty comprises the step of determining a deductible.

34. A system for warranting a portfolio of securities comprising:
a computer system for entering information related to warranting a portfolio of securities; and
a server system for receiving the entered information and for calculating a premium for a warranty for warranting a portfolio of securities and the server system for transmitting the premium to the computer system.

35. The system of claim 34 wherein the computer system is capable of having entered therein information related to a length for a warranty.

36. The system of claim 34 wherein the computer system is capable of having entered therein information related to a deductible amount for a warranty.

37. The system of claim 34 wherein the computer system is capable of having entered therein information related to an amount of coverage for a warranty.

38. The system of claim 34 wherein the computer system is capable of having entered therein information related to a number of securities in a portfolio.

39. The system of claim 34 wherein the server system is capable of recalculating a premium amount based upon revised information entered in the computer system.

40. A method for warranting a portfolio of securities comprising the steps of:
obtaining an interest in a portfolio of securities; and
purchasing a warranty for warranting against a change in the value of the portfolio of securities.

41. The method of claim 40 wherein the step of purchasing a warranty comprises the step of determining a premium to be paid for purchasing the warranty.

42. The method of claim 40 wherein the step of purchasing a warranty comprises the step of determining the length of the warranty.

43. The method of claim 40 wherein the step of purchasing a warranty comprises the step of determining an amount of coverage.

44. The method of claim 40 wherein the step of purchasing a warranty comprises the step of determining a deductible.

45. A method of warranting a portion of a portfolio of securities comprising the steps of:
obtaining an interest in a portfolio of securities; and
purchasing a warranty for warranting against a change in the value of a portion of the portfolio.

46. The method of claim 45 wherein the step of purchasing a warranty comprises the step of determining a premium to be paid for purchasing the warranty.

47. The method of claim 45 wherein the step of purchasing a warranty comprises the step of determining the length of the warranty.

48. The method of claim 45 wherein the step of purchasing a warranty comprises the step of determining an amount of coverage.

49. The method of claim 45 wherein the step of purchasing a warranty comprises the step of determining a deductible.

50. A system for warranting a portion of a portfolio of securities comprising:
a computer system for entering information related to warranting a portion of a portfolio of securities; and
a server system for receiving the entered information and for calculating a premium for a warranty for warranting a portion of a portfolio of securities and the server system for transmitting the premium to the computer system.

51. The system of claim 50 wherein the computer system is capable of having entered therein information related to a length for the warranty.

52. The system of claim 50 wherein the computer system is capable of having entered therein information related to a deductible amount for the warranty.

53. The system of claim 50 wherein the computer system is capable of having entered therein information related to an amount of coverage for the warranty.

54. The system of claim 50 wherein the server system is capable of recalculating a premium amount based upon revised information entered in the computer system.

55. A method for purchasing a warranty for a security over a computer network comprising the steps of:
accessing a web site for purchasing a warranty for a security;
entering information relating to a security to be warranted;
reviewing information relating to a premium to be paid for the warranty for a security; and
paying for the premium.

56. The method of claim 55 wherein the step of entering information comprises the step of entering the name of the security to be warranted.

57. The method of claim 55 wherein the step of entering information comprises the step of entering a value of the security to be warranted.

58. The method of claim 55 wherein the step of entering information comprises the step of entering an amount of coverage.

59. The method of claim 55 wherein the step of entering information comprises the step of entering a deductible amount.

60. The method of claim 55 wherein the step of entering information comprises the step of entering a term.

61. The method of claim 55 wherein the step of entering information comprises the step of calculating a premium.

62. The method of claim 55 wherein the step of reviewing information comprises the step of determining whether the premium should be accepted, rejected, or recalculated.

63. The method of claim 55 further comprising the steps of entering information relating to a second security to be warranted, reviewing information relating to a second premium to be paid for the warranty for a second security to be warranted, and paying the second premium.

64. A system for purchasing a warranty for a security comprising a computer system capable of being assessed over an Internet, the computer system capable of providing various screens and for receiving entered information relating to a security to be warranted, determining a premium to be paid for the warranty for a security, and for receiving entered information relating to payment for the premium.

65. The system of claim 64 wherein the computer system is further capable of receiving entered information relating to a term for the warranty for a security.

66. The system of claim 64 wherein the computer system is further capable of receiving entered information relating to a deductible amount for the warranty for a security.

67. The system of claim 64 wherein the computer system is further capable of receiving entered information relating to an amount of coverage for the warranty for a security.

68. The system of claim 64 wherein the computer system is further capable of receiving entered information related to warranting a second security.

69. The system of claim 64 wherein the computer system is further capable of recalculating the premium based upon revised information entered in the computer system.

70. A method for purchasing a warranty for a portfolio of securities over a computer network comprising the steps of:
accessing a web site for purchasing a warranty for a portfolio of securities;
entering information relating to portfolio of securities to be warranted;
reviewing information relating to a premium to be paid for the warranty for the portfolio; and
paying for the premium.

71. The method of claim 70 wherein the step of entering information comprises the step of entering the names of the securities to be warranted.

72. The method of claim 70 wherein the step of entering information comprises the step of calculating a premium.

73. The method of claim 70 wherein the step of reviewing information comprises the step of determining whether the premium should be accepted, rejected, or recalculated.

74. The method of claim 70 wherein the step of paying comprises the step of entering information relating to a payment method.

75. A method for providing a warranty for a security over a computer network comprising the steps of:
providing a web site for purchasing a warranty for a security;
receiving information relating to a security to be warranted;
determining a premium to be paid for the warranty for a security; and
receiving payment for the premium.

76. The method of claim 75 wherein the step of receiving information comprises the step of receiving the name of the security to be warranted.

77. The method of claim 75 wherein the step of receiving information comprises the step of receiving a value of the security to be warranted.

78. The method of claim 75 wherein the step of receiving information comprises the step of receiving an amount of coverage.

79. The method of claim 75 wherein the step of receiving information comprises the step of receiving a deductible amount.

80. The method of claim 75 wherein the step of receiving information comprises the step of receiving a term.

81. The method of claim 75 further comprising the steps of receiving information relating to a second security to be warranted, determining a second premium to be paid for the warranty for a second security to be warranted, and receiving payment of the second premium.

82. A method for providing a warranty for a portfolio of securities over a computer network comprising the steps of:
providing a web site for purchasing a warranty for a portfolio of securities;
receiving information relating to a portfolio of securities to be warranted;
determining a premium to be paid for the warranty for a portfolio of securities to be warranted; and
receiving payment for the premium.

83. The method of claim 82 wherein the step of receiving information comprises the step of receiving a name of each of the securities within a portfolio to be warranted.

84. The method of claim 82 wherein the step of receiving information comprises the step of receiving a value of each of the securities within a portfolio to be warranted.

85. The method of claim 82 wherein the step of receiving information comprises the step of receiving an amount of coverage of each of the securities within a portfolio to be warranted.

86. The method of claim 82 wherein the step of receiving information comprises the step of receiving a deductible amount for each of the securities within a portfolio to be warranted.

87. The method of claim 82 wherein the step of receiving information comprises the step of receiving a term for each of the securities within a portfolio to be warranted.

88. A method for purchasing a warranty for a portion of a portfolio of securities over a computer network comprising the steps of:
accessing a web site for purchasing a warranty for a portion of a portfolio of securities;
entering information relating to the portfolio of securities to be warranted;
reviewing information relating to a premium to be paid for the warranty for the portion of the portfolio of securities; and
paying for the premium.

89. The method of claim 88 wherein the step of entering information comprises the step of entering the names of the securities in the portfolio to be warranted.

90. The method of claim 88 wherein the step of entering information comprises the step of entering a value of the portfolio to be warranted.

91. The method of claim 88 wherein the step of entering information comprises the step of entering an amount of coverage.

92. The method of claim 88 wherein the step of entering information comprises the step of entering a deductible amount.

93. The method of claim 88 wherein the step of entering information comprises the step of entering a term.

94. The method of claim 88 wherein the step of entering information comprises the step of calculating a premium.

95. The method of claim 88 wherein the step of reviewing information comprises the step of determining whether the premium should be accepted, rejected, or recalculated.

96. A system for purchasing a warranty for a portfolio of securities comprising a computer system capable of being assessed over an Internet, the computer system capable of providing various screens and for receiving entered information relating to a portfolio of securities to be warranted, determining a premium to be paid for the warranty for the portfolio, and for receiving entered information relating to payment for the premium.

97. The system of claim 96 wherein the computer system is further capable of receiving entered information relating to a term for the warranty for the portfolio.

98. The system of claim 96 wherein the computer system is further capable of receiving entered information relating to a deductible amount for the warranty for the portfolio.

99. The system of claim 96 wherein the computer system is further capable of receiving entered information relating to an amount of coverage for the warranty for the portfolio.

100. The system of claim 96 wherein the computer system is further capable of receiving entered information related to warranting a portion of the portfolio.

101. The system of claim 96 wherein the computer system is further capable of recalculating the premium based upon revised information being entered in the computer system.

102. A system for purchasing a warranty for a portion of a portfolio of securities comprising a computer system capable of being assessed over an Internet, the computer system capable of providing various screens and for receiving entered information relating to a portion of a portfolio of securities to be warranted, determining a premium to be paid for the warranty for a portion of a portfolio of securities, and for receiving entered information relating to payment for the premium.

103. The system of claim 102 wherein the computer system is further capable of receiving entered information relating to a term for the warranty for a portion of a portfolio of securities.

104. The system of claim 102 wherein the computer system is further capable of receiving entered information relating to a deductible amount for the warranty for a portion of a portfolio of securities.

105. The system of claim 102 wherein the computer system is further capable of receiving entered information relating to an amount of coverage for the warranty for a portion of a portfolio of securities.

106. The system of claim 102 wherein the computer system is further capable of recalculating the premium based upon revised information being entered in the computer system.
